(19) United States
(12) Patent Application Publication
(10) Pub. No.: US 2018/0032265 A1
(43) Pub. Date: Feb. 1, 2018

(54) STORAGE ASSIST MEMORY MODULE

(71) Applicant: Dell Products L.P., Round Rock, TX (US)

(72) Inventor: Gary B. KOTZUR, Austin, TX (US)

(73) Assignee: Dell Products L.P., Round Rock, TX (US)

(21) Appl. No.: 15/220,197

(22) Filed: Jul. 26, 2016

(51) Int. Cl. G06F 3/06

(52) U.S. Cl. CPC G06F 3/0613; G06F 3/0659; G06F 3/0683

(57) ABSTRACT

In accordance with embodiments of the present disclosure, a memory system may include a memory module comprising a plurality of memory chips configured to store data and a hardware accelerator communicatively coupled to the memory chips and configured to, in response to an input/output operation to a storage resource, perform a storage function to assist movement and calculation of data in the memory system associated with the input/output operation.

### TECHNICAL FIELD

The present disclosure relates in general to information handling systems, and more particularly to systems and methods for improvement of performance and signal integrity in memory systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often use storage resources (e.g., hard disk drives and/or arrays thereof) to store data. Typically, storage solutions are software-based or hardware-based. Software-based solutions may value hardware agnosticity at the sacrifice of performance. Hardware-based solutions may achieve higher performance with smaller solutions and lower power, but may require specialized hardware and firmware that are tightly coupled to one another. With the advent and momentum in the industry of Software-Defined Storage, storage software may increasingly be executed on commodity servers, which may be less efficient due to absence of hardware-accelerated silicon devices and resistance to “locking-in” to a single vendor. Accordingly, architectures need to solve for either performance or hardware agnosticity.

### SUMMARY

In accordance with the teachings of the present disclosure, the disadvantages and problems associated with storage systems may be reduced or eliminated.

In accordance with embodiments of the present disclosure, a memory system may include a memory module comprising a plurality of memory chips configured to store data and a hardware accelerator communicatively coupled to the memory chips and configured to, in response to an input/output operation to a storage resource, perform a storage function to assist movement and calculation of data in the memory system associated with the input/output operation.

In accordance with these and other embodiments of the present disclosure, a method may include receiving, at a hardware accelerator of a memory module comprising the hardware accelerator and a plurality of memory chips communicatively coupled to the hardware accelerator, an indication of an input/output operation to a storage resource. The method may also include in response to an input/output operation to a storage resource, performing a storage function to assist movement and calculation of data in a memory system associated with the input/output operation.

In accordance with these and other embodiments of the present disclosure, an information handing system may include a processor and a memory module comprising a plurality of memory chips configured to store data and a hardware accelerator communicatively coupled to the memory chips and configured to, in response to an input/output operation to a storage resource, perform a storage function to assist movement and calculation of data in a memory system associated with the input/output operation.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system in accordance with embodiments of the present disclosure;

FIG. 2 illustrates a flow chart of an example method for performing storage assist, in accordance with embodiments of the present disclosure;

FIG. 3 illustrates a flow chart of an example method for performing storage assist with respect to parity calculation, in accordance with embodiments of the present disclosure;

FIG. 4 illustrates translation mapping that may be performed by a hardware accelerator of a memory module to map from a stripe format to a memory map within a memory system, in accordance with embodiments of the present disclosure; and

FIGS. 5A and 5B illustrate front and back views of selected components of a memory module, in accordance with embodiments of the present disclosure.

### DETAILED DESCRIPTION

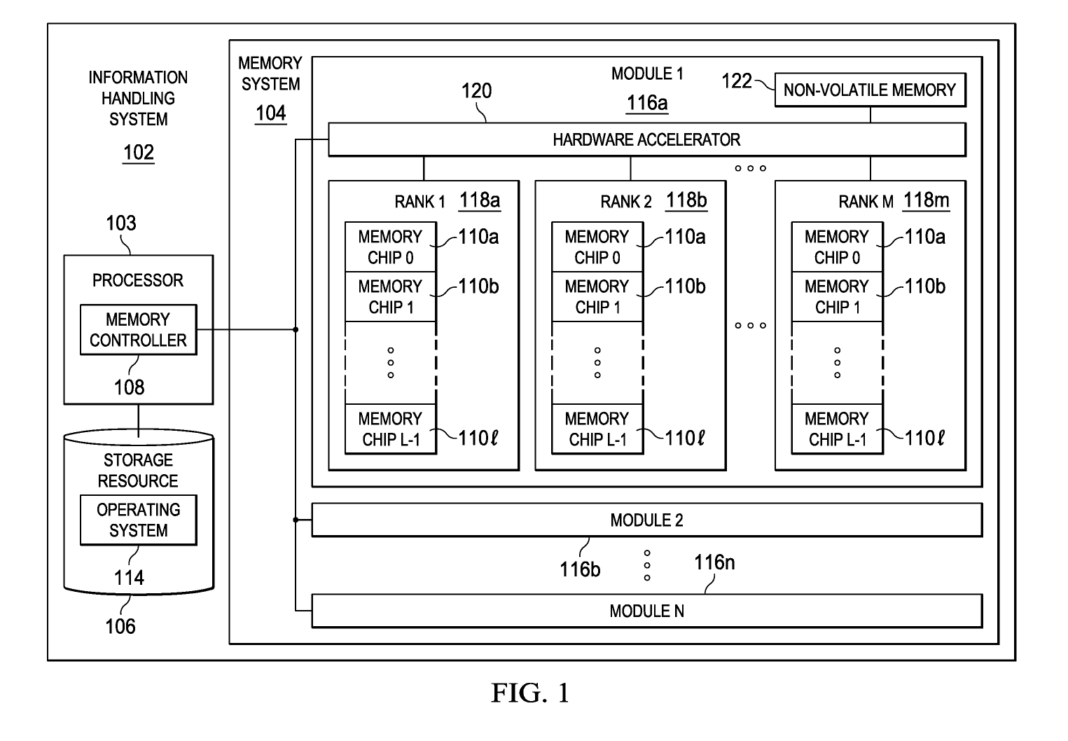

Preferred embodiments and their advantages are best understood by reference to FIGS. 1 through 5B, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102 in accordance with certain embodiments of the present disclosure. In certain embodiments, information handling system 102 may comprise a computer chassis or enclosure (e.g., a server chassis holding one or more server blades). In other embodiments, information handling system 102 may be a personal computer (e.g., a desktop computer or a portable computer). As depicted in FIG. 1, information handling system 102 may include a processor 103, a memory system 104 communicatively coupled to processor 103, and a storage resource 106 communicatively coupled to processor 103.

Processor 103 may include any system, device, or apparatus configured to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored and/or communicated by one or more of memory system 104, storage resource 106, and/or another component of information handling system 102. As shown in FIG. 1, processor 103 may include a memory controller 108.

Memory controller 108 may be any system, device, or apparatus configured to manage and/or control memory system 104. For example, memory controller 108 may be configured to read data from and/or write data to memory modules 116 comprising memory system 104. Additionally or alternatively, memory controller 108 may be configured to refresh memory modules 116 and/or memory chips 110 thereof in embodiments in which memory system 104 comprises DRAM. Although memory controller 108 is shown in FIG. 1 as an integral component of processor 103, memory controller 108 may be separate from processor 103 and/or may be an integral portion of another component of information handling system 102 (e.g., memory controller 108 may be integrated into memory system 104).

Memory system 104 may be communicatively coupled to processor 103 and may comprise any system, device, or apparatus operable to retain program instructions or data for a period of time (e.g., computer-readable media). Memory system 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. In particular embodiments, memory system 104 may comprise dynamic random access memory (DRAM).

As shown in FIG. 1, memory system 104 may include one or more memory modules 116a-116n communicatively coupled to memory controller 108.

Each memory module 116 may include any system, device or apparatus configured to retain program instructions and/or data for a period of time (e.g., computer-readable media). A memory module 116 may comprise a dual in-line package (DIP) memory, a dual-inline memory module (DIMM), a Single In-line Pin Package (SIPP) memory, a Single Inline Memory Module (SIMM), a Ball Grid Array (BGA), or any other suitable memory module. In some embodiments, memory modules 116 may comprise double data rate (DDR) memory.

As depicted in FIG. 1, each memory module 116 may include a hardware accelerator 120 and memory chips 110 organized into one or more ranks 118a-118m.

Each memory rank 118 within a memory module 116 may be a block or area of data created using some or all of the memory capacity of the memory module 116. In some embodiments, each rank 118 may be a rank as such term is defined by the JEDEC Standard for memory devices. As shown in FIG. 1, each rank 118 may include a plurality of memory chips 110. Each memory chip 110 may include one or more dies for storing data. In some embodiments, a memory chip 110 may include one or more dynamic random access memory (DRAM) dies. In other embodiments, a memory chip 110 die may comprise flash, Spin-Transfer Torque Magnetoresistive RAM (STT-MRAM), Phase Change Memory (PCM), ferro-electric memory, memristor memory, or any other suitable memory device technology.

A hardware accelerator 120 may be communicatively coupled to memory controller 108 and one or more ranks 118. A hardware accelerator 120 may include any system, device, or apparatus configured to perform storage functions to assist data movement, as described in greater detail elsewhere in this disclosure. For example, an example storage function may comprise calculations associated with RAID 5, RAID 6, erasure coding, functions such as hash lookup, Data Integrity Field (DIF)/Data Integrity Extension (DIX), and/or table functions such as a redirection table. Hardware accelerator 120 may comprise an application-specific integrated circuit (ASIC), field-programmable gate array (FPGA), or other suitable processing device.

Storage resource 106 may be communicatively coupled to processor 103. Storage resource 106 may include any system, device, or apparatus operable to store information processed by processor 103. Storage resource 106 may include, for example, network attached storage, one or more direct access storage devices (e.g., hard disk drives), and/or one or more sequential access storage devices (e.g., tape drives). As shown in FIG. 1, storage resource 106 may have stored thereon an operating system (OS) 114. OS 114 may be any program of executable instructions, or aggregation of programs of executable instructions, configured to manage and/or control the allocation and usage of hardware resources such as memory, CPU time, disk space, and input and output devices, and provide an interface between such hardware resources and application programs hosted by OS 114. Active portions of OS 114 may be transferred to memory 104 for execution by processor 103.

In some embodiments, storage resource 106 may comprise a single physical storage resource (e.g., hard disk drive). In other embodiments, storage resource 106 may comprise a virtual storage resource comprising multiple physical storage resources arranged in an array (e.g., a Redundant Array of Inexpensive Disks or “RAID”) as is known in the art.

As shown in FIG. 1, memory system 104 may also include a non-volatile memory 122 comprising computer readable media for storing information that retains data after power to information handling system 102 is turned off (e.g., flash memory or other non-volatile memory).

In addition to processor 103, memory system 104, and storage resource 106, information handling system 102 may include one or more other information handling resources.

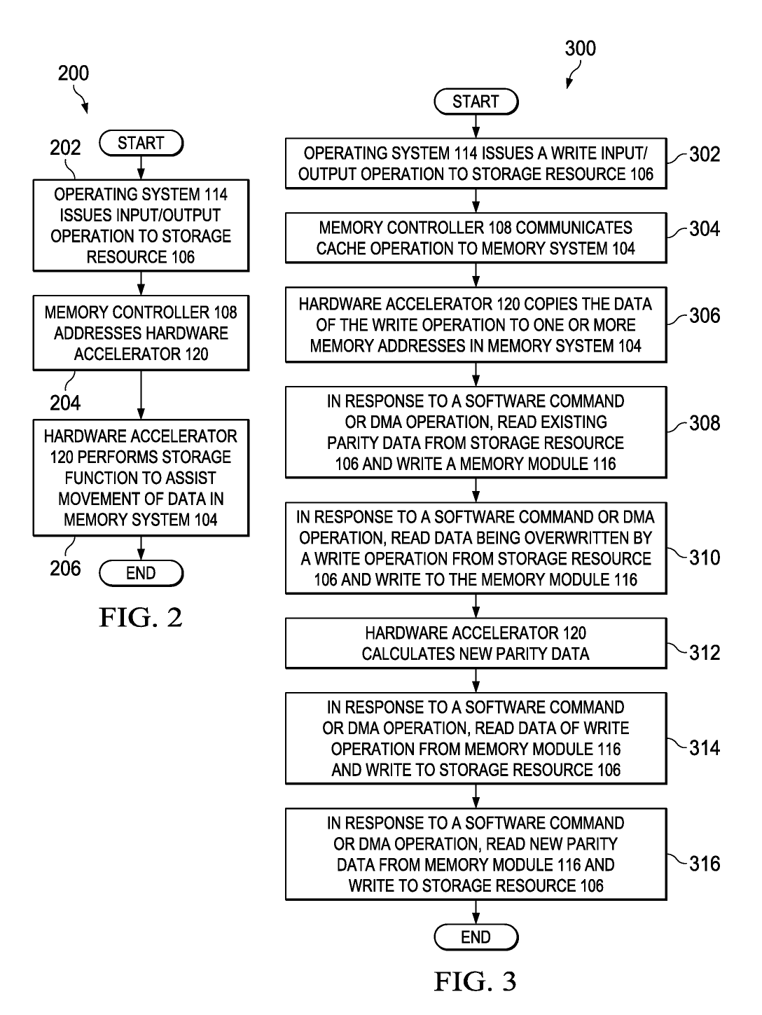

FIG. 2 illustrates a flow chart of an example method 200 for performing storage assist, in accordance with embodiments of the present disclosure. According to some embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, a software RAID via operating system 114 may issue an input/output operation to storage resource 106, for which a portion of memory system 104 may serve as a cache (e.g., a write-back cache) for storage resource 106. At step 204, in connection with the input/output operation, memory controller 108 may address hardware accelerator 120 within memory system 104. At step 206, hardware accelerator 120 may perform a storage function to assist movement and computation of data in a memory module 116 of memory system 104.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using hardware accelerator 120, and/or any other system operable to implement method 200. In certain embodiments, method 200 may be implemented partially or fully in software and/or firmware embodied in computer-readable media.

FIG. 3 illustrates a flow chart of an example method 300 for performing storage assist with respect to a parity calculation, in accordance with embodiments of the present disclosure. According to some embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, operating system 114 may issue a write input/output operation to storage resource 106, which may implement a RAID 5 and for which a portion of memory system 104 may serve as a cache (e.g., a write-back cache) for storage resource 106. At step 304, in connection with the input/output operation, memory controller 108 may communicate a cache operation to memory system 104 by addressing a memory module 116. In response, hardware accelerator 120 may perform the storage function of parity calculation to assist movement and computation of data in such memory module 116 of memory system 104. For example, at step 306, hardware accelerator 120 may copy the data of the write operation to one or more memory addresses in memory system 104. At step 308, in response to a software command or Direct Memory Access (DMA) operation, existing parity data (e.g., parity data existing prior to the write operation) may be read from storage resource 106 and written to a memory module 116. Hardware accelerator 120 may receive the parity data and may write the parity data or perform a logical exclusive OR (XOR) operation with the received parity data and new data associated with the write operation and write the result to a memory address in memory system 104. At step 310, in response to a software command or DMA operation, data being overwritten by a write operation from storage resource 106 may be read from storage resource 106 and written to a memory module 116. Hardware accelerator 120 may receive the parity data and may write or XOR with new data of the write operation to memory address in memory system 104. At step 312, hardware accelerator 120 may calculate new parity data (e.g., new parity data equals the logical exclusive OR of the existing parity data, the data being overwritten, and the new data written as a result of the write operation).

At step 314, in response to a software command or DMA operation, data from the write operation may be read from memory module 116 and written to storage resource 106. At step 316, in response to a software command or DMA operation, the new parity data may be read from memory module 116 and written to storage resource 106.

Although FIG. 3 discloses a particular number of steps to be taken with respect to method 300, method 300 may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using hardware accelerator 120, and/or any other system operable to implement method 300. In certain embodiments, method 300 may be implemented partially or fully in software and/or firmware embodied in computer-readable media.

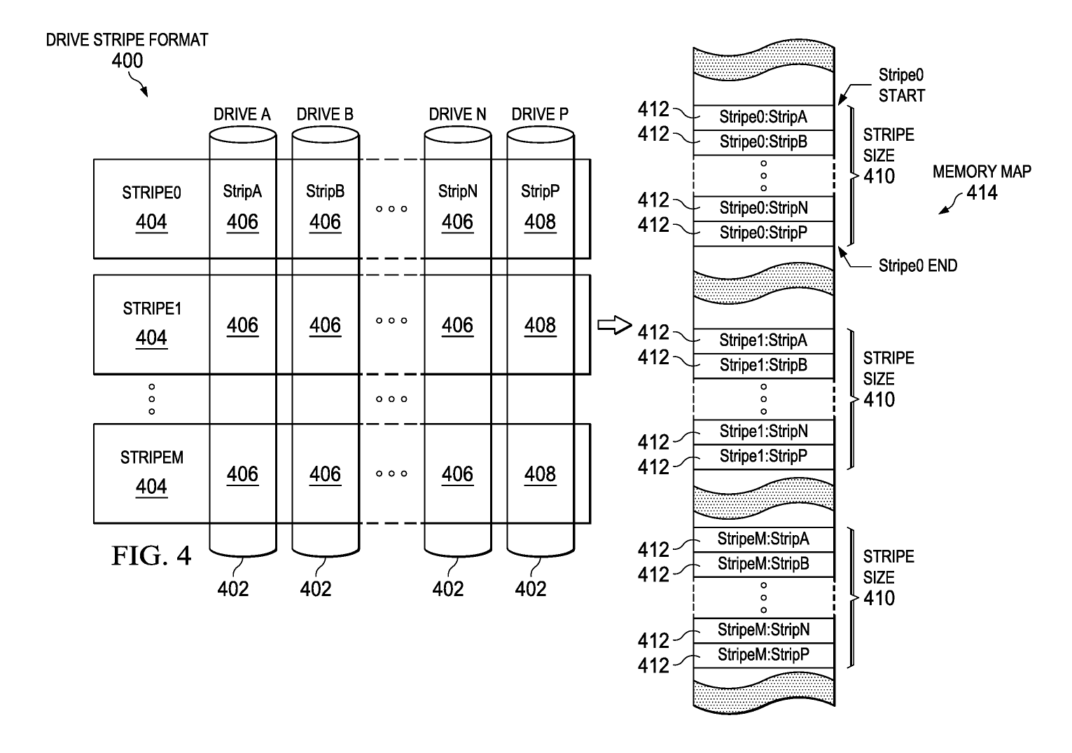

FIG. 4 illustrates translation mapping that may be performed by hardware accelerator 120 of memory module 116 to map from a stripe format (e.g., as present is a set of RAID drives) to a memory map within memory system 104, in accordance with embodiments of the present disclosure. As shown in FIG. 4, a storage system 400 may comprise multiple physical storage resources 402. Multiple stripes 404 of data may be written across the multiple physical storage resources 402, wherein each stripe may include a plurality of data strips 406 and a parity strip 408 storing parity data computed from data of data strips 406 of the same stripe 404, as is known in the art. FIG. 4 depicts an example relating to RAIDS, but other RAID arrangements (e.g., RAID6) may use similar approaches. As shown in FIG. 4, each stripe 404 may be mapped to corresponding memory location 410 in memory system 104, with individual strips 406 and 408 mapped to corresponding addresses 412 within such location 410 in memory map 414. Thus, in operation, when hardware accelerator 120 performs a storage function to assist data movement (e.g., step 206 of FIG. 2, parity calculations of steps 308-316 of FIG. 3), hardware accelerator 120 may perform direct memory access (DMA) operations to read data from memory within memory system 104 that is mapped to a corresponding drive stripe format of storage system 400. For example, if full parity build is required, hardware accelerator 120 may use contents of strips 406 and 408 stored in memory in order to build parity (e.g., according to the equation StripP_{new}=StripA_{new}+StripB_{new}+. . . +StripN_{new}) . As another example, if updating parity in response to writing of new data, hardware accelerator 120 may use contents of strips 406 and 408 stored in memory as well as the new strip data of the write operation to update parity (e.g., according to the equation StripP_{new}=StripP_{old}+StripA_{new}+StripA_{old}+. . . +StripN_{new}+StripN_{old}, wherein only data in data strips to be updated may be used in the parity calculation). As a further example, if rebuilding a physical storage resource 402 (e.g., in response to failure and replacement), hardware accelerator 120 may use contents of strips 406 and 408 stored in memory to rebuild the physical storage resource 402 (e.g., according to the equation StripR_{new}=StripA_{old}+StripB_{old}+. . . +StripN_{old}+StripP_{old}).

To perform its functionality, hardware accelerator may operate in accordance with an application programming interface (API). For example, information that hardware accelerator 120 may communicate from a memory module 116 may include a memory range within volatile memory of a memory map (e.g., memory map 414), a memory map range of non-volatile memory 122, serial presence detect addressing an information, non-volatile memory 122 addressing an information, RAID levels supported (e.g., RAID1, 5, 6, etc.), whether support is included for one pass or multi-pass generation, and status flags (e.g., setting a complete status flag when parity generation is complete). As another example, information that hardware accelerator 120 may receive (e.g., from a RAID controller) may include various information regarding each respective RAID group (e.g., RAID group identity, strip size, number of physical storage resources in a RAID group, identity of drives in the RAID group), stripe size, logical block address (LBA) range of a RAID group, RAID type (e.g., RAID 1, 5, 6, etc.), disk data format, LBA ranges of strips, identities of updated data strips and parity strips per respective physical storage resource, identities of failed physical storage resources, identities of peer physical storage resources of failed physical storage resources, and identities of target physical storage resources for rebuild operations.

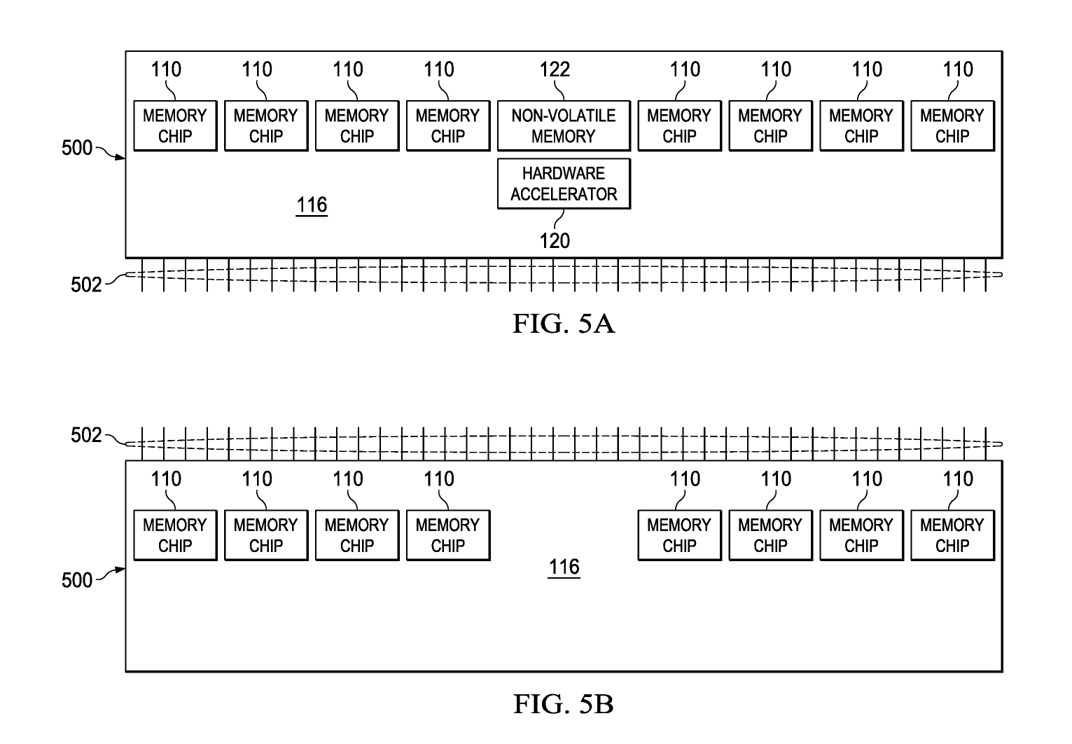

FIGS. 5A and 5B illustrate front and back views of selected components of a memory module 116, in accordance with embodiments of the present disclosure. As shown in

FIGS. 5A and 5B, memory module 116 may be embodied on a substrate 500 (e.g., printed circuit board substrate) having device pins 502 for coupling substrate 500 to a corresponding receptacle connector. Hardware accelerator 120, non-volatile memory 122, and memory chips 110 may all be implemented as integrated circuit packages mounted on substrate 500. As so constructed, memory module 116 may support one or more implementations or embodiments. For example, in a first embodiment all memory modules 110 may comprise dynamic RAM and only one memory map (e.g., memory map 414) may need to be maintained. Such embodiment may enable “on-the-fly” parity creation as data is read from a storage system, and all memory writes may be performed as read-modify-writes. In such embodiment, parity creation threads may include initial builds, updates, and rebuilds. In such embodiment, hardware accelerator 120 may also maintain one scratchpad per parity creation thread. In such embodiment, memory data may be backed up on memory module 116 or externally.

A second embodiment may be similar to that of the first embodiment above, except that hardware accelerator 120 may maintain a single scratchpad buffer, and parity creation may be a background operation, once data transfer from physical storage resources is complete. In such embodiments, a status flag may be needed to indicate when the background operation is complete.

A third embodiment may be similar to the first embodiment above, with the exception that some of memory modules 110 (e.g., memory modules shown in FIG. 5B) may include non-volatile memory, in which case hardware accelerator 120 must maintain two memory maps: one for the volatile memory and one for the non-volatile memory. With such third embodiment, no backup is required for data due to presence of the non-volatile memory.

A fourth embodiment may be similar to the third embodiment, except that hardware accelerator 120 may maintain a single scratchpad buffer, and parity creation may be a background operation, once data transfer from physical storage resources is complete. In such embodiments, a status flag may be needed to indicate when the background operation is complete.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A memory system comprising:
a memory module comprising:
a plurality of memory chips configured to store data; and
a hardware accelerator communicatively coupled to the memory chips and configured to, in response to an input/output operation to a storage resource, perform a storage function to assist movement and calculation of data in the memory system associated with the input/output operation.

2. The memory system of claim 1, wherein the storage function comprises calculation of parity associated with data associated with the input/output operation.

3. The memory system of claim 1, wherein the storage function comprises a calculation associated with the input/output operation and the storage resource comprises a Redundant Array of Inexpensive Disks data set.

4. The memory system of claim 1, wherein the storage function comprises a calculation associated with erasure coding.

5. The memory system of claim 1, wherein the storage function comprises a hash lookup.

6. The memory system of claim 1, wherein the storage function comprises a Data Integrity Field/Data Integrity Extension operation.

7. The memory system of claim 1, wherein the storage function comprises a redirection table.

8. A method comprising:
receiving, at a hardware accelerator of a memory module comprising the hardware accelerator and a plurality of memory chips communicatively coupled to the hardware accelerator, an indication of an input/output operation to a storage resource; and
in response to an input/output operation to a storage resource, performing a storage function to assist movement and calculation of data in a memory system associated with the input/output operation.

9. The method of claim 8, wherein the storage function comprises calculation of parity associated with data associated with the input/output operation.

10. The method of claim 8, wherein the storage function comprises a calculation associated with the input/output operation and the storage resource comprises a Redundant Array of Inexpensive Disks data set.

11. The method of claim 8, wherein the storage function comprises a calculation associated with erasure coding.

12. The method of claim 8, wherein the storage function comprises a hash lookup.

13. The method of claim 8, wherein the storage function comprises a Data Integrity Field/Data Integrity Extension operation.

14. The method of claim 8, wherein the storage function comprises a redirection table.

15. An information handing system, comprising:
a processor; and
a memory module comprising:
a plurality of memory chips configured to store data; and
a hardware accelerator communicatively coupled to the memory chips and configured to, in response to an input/output operation to a storage resource, perform a storage function to assist movement and calculation of data in a memory system associated with the input/output operation.

16. The information handing system of claim 15, wherein the storage function comprises calculation of parity associated with data associated with the input/output operation.

17. The information handing system of claim 15, wherein the storage function comprises a calculation associated with the input/output operation and the storage resource comprises a Redundant Array of Inexpensive Disks data set.

18. The information handing system of claim 15, wherein the storage function comprises a calculation associated with erasure coding.

19. The information handing system of claim 15, wherein the storage function comprises a hash lookup.

20. The information handing system of claim 15, wherein the storage function comprises a Data Integrity Field/Data Integrity Extension operation.

21. The information handing system of claim 15, wherein the storage function comprises a redirection table.
